(19) United States
(12) Patent Application Publication
(10) Pub. No.: US 2025/0338222 A1
(43) Pub. Date: Oct. 30, 2025

(54) METHOD FOR SIMPLE CALCULATION OF ROAD USERS' NEXT RECEPTION TIME AND LOW-POWER V2X RECEIVER USING SUCH METHOD

(71) Applicant: Autotalks Ltd., Kfar Netter (IL)

(72) Inventor: Onn Haran, Kfar Netter (IL)

(21) Appl. No.: 19/096,767

(22) Filed: Apr. 1, 2025

Related U.S. Application Data
(60) Provisional application No. 63/640,405, filed on Apr. 30, 2024.

(51) Int. Cl. H04W 52/02; G08G 1/16; H04W 4/40

(52) U.S. Cl. CPC H04W 52/0248; G08G 1/164; H04W 4/40

(57) ABSTRACT

A method and non-transitory computer readable medium for reducing power requirements in a battery-operated V2X device associated with a self road user, the method comprising receiving in a current slot a message from a received road user, the reception having an associate reception energy; based on data in the message, predicting a lowest possible time-to-collision (TTC) between the self road user and the received road user, calculating a next reception time of the received road user in the current slot using the predicted lowest possible TTC and an adjustable threshold, and based on the calculated next reception time, deciding whether to receive or skip a next slot. Associated apparatus comprises a reception energy and time match module configured to compare a last energy associated with a message received from a road user occupying a slot with a previously known energy for the slot occupied by the same road user, and a V2X receiver configured to skip the remainder of the slot if the last energy for the slot does not significantly deviate from the previously known energy for the slot, or if a next reception time for the user occupying the slot has not yet been reached, thereby reducing the power requirements in the battery-operated V2X device.

### CROSS REFERENCE TO RELATED APPLICATIONS

This application claims the benefit of U.S. Provisional patent application 63/640,405 filed Apr. 30, 2024, which is incorporated herein by reference in its entirety. FIELD

Embodiments disclosed herein relate generally to vehicle-to-everything (V2X) communications (or simply “V2X”) and in particular to apparatus and methods for calculating road users' next reception time to decrease road user risk and thereby promote safety. As used herein, “road users” may refer to pedestrians, cyclists, motorcyclists and drivers, or to any entity with a transportation device that can use a smartphone to add V2X to its transportation device.

### BACKGROUND

The V2X communication range spans hundreds of meters. Messages from many road users are received, but only a few of those road users, those posing potential safety risks to a battery-operated self-device (carried by or associated with a “self road user”), need to be constantly received. To conserve processing resources, the remaining road users (i.e. those not posing potential safety risks) can be received less frequently. For battery-operated devices, road users should only be received when their data is relevant, with unnecessary packets filtered at the PHY level.

The most precise method to determine reception timing involves map matching, where roads and lanes of both the self-device and the received road user are identified. The distance to an expected collision point is then used to calculate a Time-To-Collision (TTC). Another method relates to geometric line-crossing, which involves an algebraic calculation where virtual lines are drawn based on the current and previous locations of self and remote road users, and where the crossing point of these lines is calculated to determine the actual distance between the two (self and remote) road users. However, both methods demand extensive processing, geometric computations, and complex algorithms, which significantly drain battery life. Even without map matching and line-crossing, calculations alone impose a substantial processing load. Given that thousands of messages can be received per second, such complex computations should be minimized.

Determining the next reception time must ensure no safety risks are missed while avoiding an overly low value (i.e. by setting the next reception time to an earlier time than it should actually be), which would increase power consumption and compromise the feasibility of a battery-powered device. A simple method is needed to analyze the safety risks without calculating future paths.

### SUMMARY

In various examples, there are provided methods for reducing power requirements in a battery-operated V2X device associated with a self-road user, a method comprising: receiving in a current slot a message from a received road user, the reception having an associate reception energy; based on data in the message, predicting a lowest possible TTC between the self-road user and the received road user; calculating a next reception time of the received road user in the current slot using the predicted lowest possible TTC and an adjustable threshold; and based on the calculated next reception time, deciding whether to receive or skip a next slot, whereby the skipping of the next slot reduces the power requirements in the battery-operated V2X device.

In various examples, there are provided computer program product, comprising: a non-transitory tangible storage medium readable by a processing circuit and storing instructions for execution by the processing circuit for performing a method for reducing power requirements in a battery-operated V2X device associated with a self-road user, the method comprising steps as above.

In some examples, wherein if the predicted TTC is above the adjustable threshold, the calculating the next reception time includes calculating the next reception time based on a distance change trend, or if the predicted TTC is below the adjustable threshold, the calculating the next reception time includes checking whether the received road user is on a different road than the self road user and if yes, updating the calculated next reception time to increase a period of reduced power consumption by the battery-operated V2X device.

In some examples in which the distance change trend is one in which a current distance between the self-device and the road user is smaller than a previous distance between the self-device and the road user by a given margin, the calculating the next reception time of the received road user includes calculating the next reception time as (the predicted TTC−the threshold)/Ncloser, where Ncloser is a unitless TTC change calibration parameter. In some such examples, Ncloser=4. In some such examples, the margin ≤2 m.

In some examples in which the distance change trend is one in which a current distance between the self-device and the road user is larger than a previous distance between the self-device and the road user by a given margin, the calculating the next reception time of the received road user includes calculating the next reception time as (the predicted TTC−the threshold)/Nsame, where Nsame is a unitless TTC change calibration parameter.

In some examples, if the current distance between the self-device and the road user is larger than the previous distance between the self-device and the road user by the given margin, a method further comprises comparing the headings of the self-device and of the road user and if the headings are similar, calculating the next reception time of the received road user as (the predicted TTC−the threshold)/Nlongersame, where Nlongersame is a unitless TTC change calibration parameter.

In some examples, if the current distance between the self-device and the road user is larger than the previous distance between the self-device and of the road user by the given margin, the method further comprises comparing the headings of the self-device and the road user and if the headings are not similar, calculating the next reception time of the received road user as (the predicted TTC−the threshold)/Nlongeropposite, where Nlongeropposite is a unitless TTC change calibration parameter.

In various examples, there is provided an apparatus for reducing power requirements in a battery-operated V2X device associated with a self-road user, comprising: a reception energy and time match module configured to compare a last energy associated with a message received from a road user occupying a slot with a previously known energy for the slot occupied by the same road user; and a V2X receiver configured to skip the remainder of the slot if the last energy for the slot does not significantly deviate from the previously known energy for the slot, or if a next reception time for the user occupying the slot has not yet been reached, thereby reducing the power requirements in the battery-operated V2X device.

In some examples, an apparatus further comprises a next reception time calculation module configured to calculate and predict the next reception time using content of the message.

In some examples, an apparatus further comprises a database for storing the next reception time and the last energy received from each road user.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way.

FIG. 1 illustrates in a flow chart an embodiment of a method for a simple calculation of a road user's next reception time (also referred to as “time till next reception”);

FIG. 2 provides in a flow chart details of a step in the method of FIG. 1 that calculates a next reception time for a “not tracked” road user;

FIG. 3 provides in a flow chart details of a step in the method of FIG. 1 that calculates a next reception time for a “tracked” road user;

FIG. 4 illustrates a block diagram of an enhanced low-power V2X receiver that utilizes next reception time calculation according to a method described herein;

FIG. 5 illustrates in a flow chart an enhanced low-power V2X receiver operation that utilizes next reception time calculation according to a method described herein;

FIG. 6 illustrates an example of a scenario used for simple calculation of road users' next reception time.

### DETAILED DESCRIPTION

Various embodiments disclosed herein teach a method and apparatus for a simple calculation of road users' next reception time. The next reception time is calculated through identifying the risk posed by road users without relying on map matching or geometric line-crossing calculations.

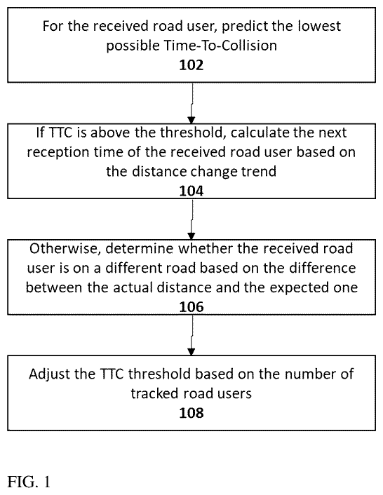

FIG. 1 illustrates in a flow chart an embodiment of a method for a simple calculation of road users' next reception time. The operation begins at step 102 after a message is received in a battery operated self-device (also referred to as “received road user”), its authenticity is verified and its content is parsed. The lowest possible TTC is then predicted. This prediction assumes a potential future movement of both self and received road users that may exceed the current speed of both the self-device and the road user to avoid overlooking any potential risks. However, basing the TTC on unrealistic future movements can lead to unnecessary receptions, defeating energy conservation efforts. To strike a balance, the predicted TTC is calculated as follows:

$$( 1 )$$

$$Predicted TTC = Distance / [ \text{} ( max ( self - device speed , road speed ) \text{} + max ( received road user speed , road speed ) * cos ( received road user healing - self - device heading ) ] .$$

Here, “road speed” is determined as the median value of all nearby road users. This approach helps prevent the artificial inflation of the TTC during stop-and-go traffic, where temporary low speeds of the self-device or received road users could mislead the calculation, as the road users might accelerate again. Since this TTC prediction does not rely on the geometric future paths of the self-device or road users, the actual TTC value may be higher than the value calculated using this method. In theory, the self-device could have ignored more reception, but in practice, a risk might occur during that time, and that risk cannot be taken.

Next, the operation continues to step 104. If the predicted TTC exceeds a first threshold (also referred to herein as “TTC threshold”), the next reception time of the received road user is calculated based on the trend in distance changes (see below). The TTC threshold can either be static, such as 4 seconds, or dynamic, ranging from 2 to 8 seconds depending on the number of tracked road users. This dynamic adjustment helps manage processing demands in dense environments, such as intersections, by limiting the number of road users tracked, while extending the monitoring range when fewer road users are nearby, such as in rural areas.

A “tracked road user” is received continuously due to its proximity to the self road user, indicating potential risk. Therefore, all transmissions from the tracked road user must be processed. In contrast, “non-tracked” road users are received intermittently, based on a calculated next reception time that predicts the earliest point at which they might pose a risk.

Distance change trends can be treated as either a continuous function or a discrete classification into groups, such as “getting closer”, “maintaining distance,” or “moving apart”. Road users that are moving further away from the self-device can be received less frequently, whereas those getting closer require more frequent attention. The next reception time must also account for the potential for road users to change their speed in the intervening period. For example, two road users traveling in the same direction may initially move further apart but could reverse that trend due to traffic conditions. Consequently, the next reception time for road users moving in the same direction should be constrained to account for such possibilities.

Next, the operation continues to step 106. If TTC is lower than the TTC threshold, the step determines whether the received road user is on a different road by comparing the actual distance with the expected distance, calculated based on the speed and distance from the previous reception. Even if a road user has a low TTC, it should not be tracked if it is on a different road. Since the algorithm does not perform map matching, the specific road is unknown. In theory, the received road user's path history could be compared with the self-device's location if it is ahead, or the self-device's path history could be compared with the road user's location if it is behind. However, this approach is complex. A simpler alternative involves identifying a mismatch between the actual and expected distances, which suggests a significant lateral separation between the self-device and the road user. In such cases, the road user should be received periodically rather than tracked, even if the TTC is low.

Finally, the operation concludes at step 108, where the TTC threshold is adjusted based on the number of tracked road users. The target number of tracked road users depends on the platform's processing capacity. For battery-operated devices, the desired TTC threshold is typically low, for example involving 8 road users.

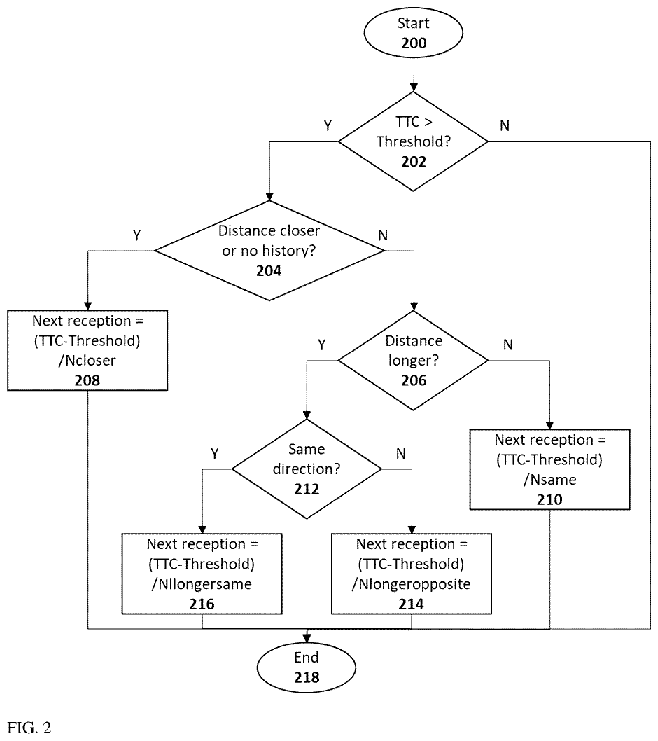

FIG. 2 provides in a flow chart details of a step in the method of FIG. 1 that calculates a next reception time for a “not tracked” road user. The goal of the next reception time is to instruct the receiver re. the period during which messages from the road user should be skipped for conserving power. It expands the actions of step 104. The process begins at step 200 whenever step 104 is invoked. The operation then moves to step 202 in which the predicted TTC calculated in step 102 is compared with the TTC threshold. If the TTC is below (smaller than) the TTC threshold, the process ends at step 218. Otherwise (TTC is above, i.e. greater than the TTC threshold), the operation proceeds to step 204 in which the current distance between the self-device and the road user is checked to determine whether it is shorter (smaller) than a previous distance between the self-device and the road user by a certain “margin” or if no previous distance is available. The margin accounts for potential position errors of 1-2 meters, requiring the current distance to be at least 2 meters shorter than the previous value to confirm a reduction in distance. In other words, position errors smaller than about 2 m are ignored. If true (the current distance is smaller than the previous distance), the operation continues to step 208 in which the time till next reception (“next reception time”) is calculated using the formula:

$$Next reception time = ( predicted TTC - TTC threshold ) / Ncloser \qquad ( 2 )$$

“Ncloser” and well as “Nsame”, “Nlongersame” and “Nlongeropposite” below are TTC change calibration parameters. They are dimensionless and represent the potential change in TTC from its current value until the next recalculation, which occurs at the next reception after the expiration of the next reception time. The parameters vary depending on the directional relationship between the road user and self, reflecting different probabilities of TTC change. A higher parameter value indicates a greater likelihood of TTC changing, resulting in an earlier reception time for a given TTC. These parameters are derived empirically from traffic simulations in cities, where the road user patterns are analyzed to determine TTC change. Typically, Ncloser=4. For instance, if the TTC is 20 seconds and the TTC threshold is 4 seconds, the next reception occurs in 4 seconds. The process then concludes at step 218.

If the condition in step 204 is false (current distance is larger than previous distance including by the margin, as above), the operation proceeds to step 206, where the current distance between the self-device and the road user is checked to see if it is larger than the previous value plus the margin. If this condition is also false, meaning the distance remains within 2 meters of the previous value, the operation moves to step 210. Here, the time till next reception is calculated using:

$$Next reception time = ( predicted TTC - TTC threshold ) / Nsame \qquad ( 3 )$$

Typically, Nsame=2.5. The process then ends at step 218.

If the condition in step 206 is true, indicating that the current distance is larger by more than 2 meters than the previous value, the operation moves to step 212. At this step, the headings of the self-device and the road user are compared. If the headings are similar, typically within 30 degrees, it is determined that the two road users are moving in the same direction and the process proceeds to step 216. Here, the time till next reception is calculated using:

Next reception time=(predicted TTC−TTC threshold)/Nlongersame (4)

Typically, Nlongersame=2. The process then ends at step 218.

If the headings are not similar in step 212, indicating that the self-device and the road user are moving in different directions, the operation continues to step 214. The time till next reception is calculated using:

$$Next reception time = ( predicted TTC - TTC threshold ) / Nlongeropposite \qquad ( 5 )$$

Typically, Nlongeropposite=1.25. The process then ends at step 218.

An optional limit can be applied to all steps determining the next reception time 208, 210, 214, and 216, restricting the time till next reception to a maximum duration, such as 10 seconds.

The simplified calculation of road users' next reception time decrease road user risk and increase safety by decreasing power consumption through simpler computations, which enables cheaper and lighter V2X devices (which might not be possible otherwise) and by not missing a safety risk. Other methods, even those applying complex map matching calculations which do not calculate the TTC pessimistically, may miss safety risks.

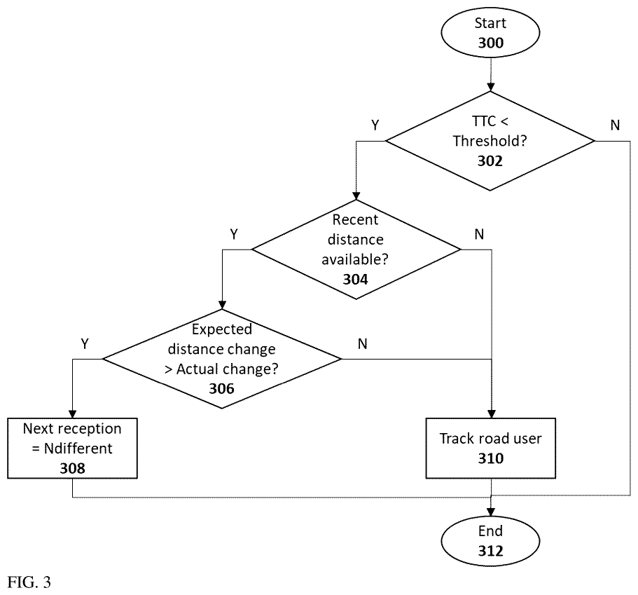

FIG. 3 provides in a flow chart details of a step in the method of FIG. 1 that calculates a next reception time for a “tracked” road user. It expands the actions of step 106. The operation begins at step 300 whenever step 106 is invoked. The operation proceeds to step 302, where the TTC calculated in step 102 is compared with the TTC threshold. If the TTC is greater than the TTC threshold, the process ends at step 312. Otherwise, it moves to step 304, where the availability of a recently received distance, typically within the last 1-2 seconds, is checked. If no recent distance is available, the road user is marked as “tracked” in step 310, meaning all its messages will be received and processed. The process then concludes at step 312.

If check 304 is yes, thus a recent distance is available, the operation continues to step 306, where the expected distance change is compared with the actual distance change (to yield a distance “delta”). To calculate the expected distance delta, the relative speed is first determined using the formula:

$$Relative speed = self - device speed + [ received road user speed \times cos ( received road user heading - self - device heading ) ] \qquad ( 6 )$$

The expected distance delta is then calculated by multiplying the relative speed by the elapsed time since the last reception, minus an margin (typically 2 meters) to account for positioning and timing interpolation errors.

If the expected distance delta is greater than the actual distance delta, the operation moves to step 308. In this case, the road user is deemed to be on a different road and should not be tracked. Instead, it is received periodically based on the parameter Ndifferent, which is typically 1 or 2 seconds. For example, if the self-device and the received road user are each traveling toward one another at 10 meters per second, but with a lateral separation of 50 meters and a current distance of 100 meters, the projected distances 1 second and 2 seconds ahead will be 83.3 meters and 68.3 meters, respectively. These changes (16.7 and 15 meters) are compared to a 20-meter distance change that would occur if both road users were on the same road. The difference indicates that the two road users are on separate roads, and the risk is low. The process then ends at step 312. If the check at step 306 is negative, meaning the expected distance aligns with the actual distance, the received road user is either on the same road or approaching on a perpendicular road. The operation then moves to step 310, where the road user is marked for tracking. The process concludes at step 312.

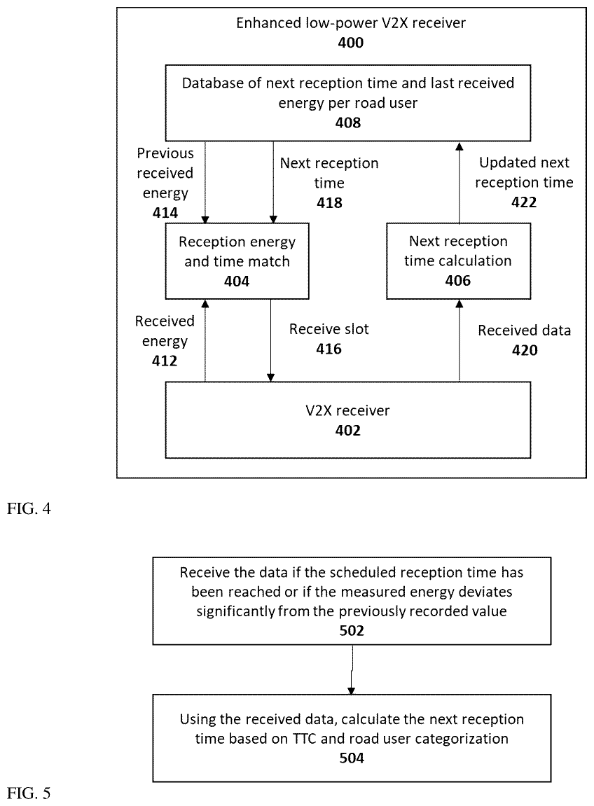

FIG. 4 presents a block diagram of an enhanced low-power V2X receiver (also referred to herein as “apparatus”) numbered 400, which utilizes next reception time calculation according to a method disclosed herein. The receiver operates in time slots, with each slot containing one or more road users. The key to power saving is skipping reception during certain slots. Skipping allows the receiver to operate for a brief portion of the total slot time, typically less than 5%, for the energy measurement. The remainder of the slot is skipped to conserve power. This is possible if a slot contains a known road user whose next reception time is in the future. To achieve this, the enhanced low-power V2X receiver must verify the identity of the road user within the slot based on its energy level (or “energy value” or simply “energy”) and determine whether it is the appropriate time for reception. These validations (energy deviation and reaching time for reception) allow the receiver to terminate reception when necessary, reducing power consumption.

Enhanced V2X receiver 400 comprises a basic V2X receiver 402, a reception energy and time match module 404, a next reception time calculation module 406 and a database 408 that stores the next reception time and the last received energy for each road user.

Module 404 is configured to match received energy and time by comparing a received energy 412 with a previous received energy 414. If the difference exceeds an energy similarity threshold (also referred to herein as second threshold”), for example 8 dB, it is assumed that a different road user (i.e. a road user other than a known road user that was supposed to be in this slot) is occupying the slot, and a receive slot command 416 is set to “Yes.” Otherwise, if a next reception time 418 calculated according to one of equations (2)-(5) was not reached, receive slot command 416 is set to “No,” conserving energy. When next reception time 418 is reached, receive slot command 416 is set to “Yes.”

After a slot is received, next reception time calculation module 406 is configured to calculate and predict an updated next reception time using the process described in FIG. 1. The action/functionality of module 406 is new and inventive. The updated next reception time 422 is then stored in database 408 along with the previously received energy 412. As a result, the system will only receive the slot again when the calculated next reception time occurs.

Enhanced low-power V2X receiver 400 may be in communication with computing device running a computer program product comprising a non-transitory tangible storage medium readable by a processing circuit and storing instructions for execution by the processing circuit for performing a method a non-transitory computer readable medium (not shown) containing instructions that when executed by at least one processor (not shown) are configured to perform a method disclosed herein.

FIG. 5 illustrates a flow chart of an enhanced low-power V2X receiver operation that utilizes a next reception time calculation according to a method described herein. The process starts at step 502, triggered at each receive slot. The received energy is measured, and if it does not significantly deviate (e.g. by the 8 dB mentioned as an energy similarity threshold in step 404) from the previously known energy for this slot, or if the next reception time for the user occupying the slot has not yet been reached, the V2X receiver can skip the remainder of the slot to conserve energy. Conversely, if the next reception time has arrived or if the received energy does not significantly deviate from the previously known value for this slot, the full slot is received. In step 504, once the message is received, the next reception time is calculated based on TTC, as described for example re. FIG. 1.

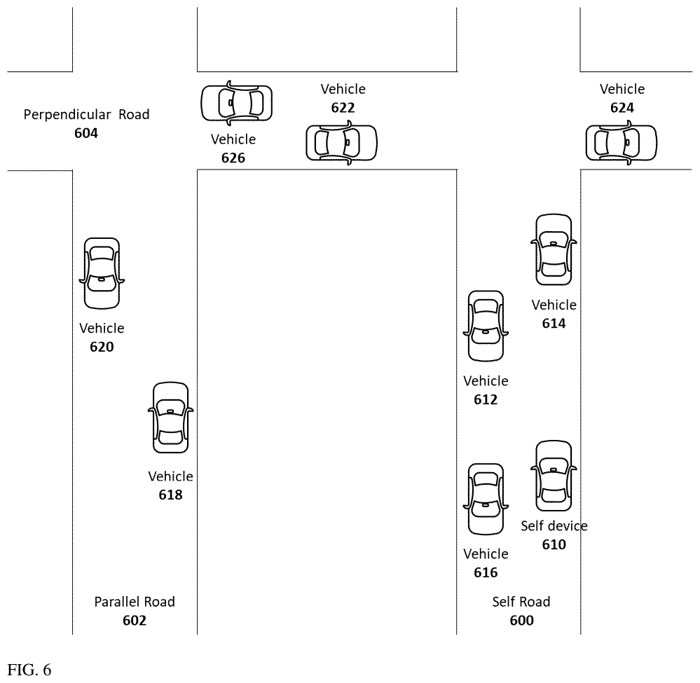

FIG. 6 shows a scenario used for a simple calculation of road users' next reception time. The scenario includes a self road 600 with a vehicle with a self-device 610 traveling upward, a parallel road 602, and a perpendicular road 604. A vehicle 612 is driving in the opposite direction and close to self-device 610 on the same road (600) and therefore it should be tracked. A vehicle 614 is driving in the same direction and close to self-device 610 on the same road and should also be tracked, regardless of any speed difference between the two vehicles. A vehicle 616 is driving in the opposite direction, and having already passed self-device 610, its distance from self-device 610 is increasing and therefore it should not be tracked.

A vehicle 618 is driving in the same direction as the vehicle with self-device 610 but on parallel road 602. A first speed mismatch between the two vehicles will trigger step 306, which will detect that the distance is not changing as expected. Consequently, vehicle 618 will be received every 1-2 seconds. A vehicle 620 is driving in the opposite direction on parallel road 620, it will similarly be received every 1-2 seconds, as indicated by step 306. A vehicle 622 is driving on perpendicular road 604 and approaching self-device 610. It will be tracked once its TTC falls below the TTC threshold. As a vehicle 624 has already passed an intersection between roads 600 and 604, even if its TTC is below the TTC threshold, step 306 will detect the expected distance mismatch, and vehicle 624 will be received every 1-2 seconds. The distance of a vehicle 626 on perpendicular road 604 relative to self-device 510 may decrease, increase, or remain static, depending on the speed difference between the two. If it is far (TTC is larger than the TTC threshold, according to next reception time equations), the next reception time will be adjusted accordingly. This example demonstrates how the algorithm dynamically determines whether road users should be tracked or received based on their proximity, direction, and relative speeds.

Unless otherwise defined, all technical and scientific terms used herein have the same meaning as commonly understood by one of ordinary skill in the art. The materials, methods, and examples provided herein are illustrative only and not intended to be limiting.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A method for reducing power requirements in a battery-operated vehicle-to-everything (V2X) device associated with a self road user, comprising:
receiving in a current slot a message from a received road user, the reception having an associate reception energy;
based on data in the message, predicting a lowest possible time-to-collision (TTC) between the self road user and the received road user;
calculating a next reception time of the received road user in the current slot using the predicted lowest possible TTC and an adjustable threshold; and
based on the calculated next reception time, deciding whether to receive or skip a next slot, whereby the skipping of the next slot reduces the power requirements in the battery-operated V2X device.

2. The method of claim 1, wherein if the predicted TTC is above the adjustable threshold, the calculating the next reception time includes calculating the next reception time based on a distance change trend, or if the predicted TTC is below the adjustable threshold, the calculating the next reception time includes checking whether the received road user is on a different road than the self road user and if yes, updating the calculated next reception time to increase a period of reduced power consumption by the battery-operated V2X device.

3. The method of claim 2, wherein the distance change trend is one in which a current distance between the self-device and the road user is smaller than a previous distance between the self-device and the road user by a given margin, and wherein the calculating the next reception time of the received road user includes calculating the next reception time as (the predicted TTC−the threshold)/Ncloser, where Ncloser is a unitless TTC change calibration parameter.

4. The method of claim 3, wherein Ncloser=4.

5. The method of claim 3, wherein the margin ≤2 m.

6. The method of claim 2, wherein the distance change trend is one in which a current distance between the self-device and the road user is larger than a previous distance between the self-device and the road user by a given margin, and wherein the calculating the next reception time of the received road user includes calculating the next reception time as (the predicted TTC−the threshold)/Nsame, where Nsame is a unitless TTC change calibration parameter.

7. The method of claim 6, wherein if the current distance between the self-device and the road user is larger than the previous distance between the self-device and the road user by the given margin, the method further comprises comparing the headings of the self-device and of the road user and if the headings are similar, calculating the next reception time of the received road user as (the predicted TTC−the threshold)/Nlongersame, where Nlongersame is a unitless TTC change calibration parameter.

8. The method of claim 6, wherein if the current distance between the self-device and the road user is larger than the previous distance between the self-device and of the road user by the given margin, the method further comprises comparing the headings of the self-device and the road user and if the headings are not similar, calculating the next reception time of the received road user as (the predicted TTC−the threshold)/Nlongeropposite, where Nlongeropposite is a unitless TTC change calibration parameter.

9. A computer program product, comprising: a non-transitory tangible storage medium readable by a processing circuit and storing instructions for execution by the processing circuit for performing a method for reducing power requirements in a battery-operated vehicle-to-everything (V2X) device associated with a self road user, the method comprising:
receiving in a current slot a message from a received road user, the reception having an associate reception energy;
based on data in the message, predicting a lowest possible time-to-collision (TTC) between the self road user and the received road user;
calculating a next reception time of the received road user in the current slot using the predicted lowest possible TTC and an adjustable threshold; and
based on the calculated next reception time, deciding whether to receive or skip a next slot, whereby the skipping of the next slot reduces the power requirements in the battery-operated V2X device.

10. The computer program product of claim 9, wherein if the predicted TTC is above the adjustable threshold, the calculating the next reception time includes calculating the next reception time based on a distance change trend, or if the predicted TTC is below the adjustable threshold, the calculating the next reception time includes checking whether the received road user is on a different road than the self road user and if yes, updating the calculated next reception time to increase a period of reduced power consumption by the battery-operated V2X device.

11. The computer program product of claim 10, wherein the distance change trend is one in which a current distance between the self-device and the road user is smaller than a previous distance between the self-device and the road user by a given margin, and wherein the calculating the next reception time of the received road user includes calculating the next reception time as (the predicted TTC−the threshold)/Ncloser, where Ncloser is a unitless TTC change calibration parameter.

12. The computer program product of claim 9, wherein Ncloser=4.

13. The computer program product of claim 9, wherein the margin ≤2 m.

14. The computer program product of claim 10, wherein the distance change trend is one in which a current distance between the self-device and the road user is larger than a previous distance between the self-device and the road user by a given margin, and wherein the calculating the next reception time of the received road user includes calculating the next reception time as (the predicted TTC−the threshold)/Nsame, where Nsame is a unitless TTC change calibration parameter.

15. The computer program product of claim 14, wherein if the current distance between the self-device and the road user is larger than the previous distance between the self-device and the road user by the given margin, the method further comprises comparing the headings of the self-device and of the road user and if the headings are similar, calculating the next reception time of the received road user as (the predicted TTC−the threshold)/Nlongersame, where Nlongersame is a unitless TTC change calibration parameter.

16. The computer program product of claim 14, wherein if the current distance between the self-device and the road user is larger than the previous distance between the self-device and of the road user by the given margin, the method further comprises comparing the headings of the self-device and the road user and if the headings are not similar, calculating the next reception time of the received road user as (the predicted TTC−the threshold)/Nlongeropposite, where Nlongeropposite is a unitless TTC change calibration parameter.

17. Apparatus for reducing power requirements in a battery-operated vehicle-to-everything (V2X) device associated with a self road user, comprising:
a reception energy and time match module configured to compare a last energy associated with a message received from a road user occupying a slot with a previously known energy for the slot occupied by the same road user; and
a V2X receiver configured to skip the remainder of the slot if the last energy for the slot does not significantly deviate from the previously known energy for the slot, or if a next reception time for the user occupying the slot has not yet been reached, thereby reducing the power requirements in the battery-operated V2X device.

18. The apparatus of claim 17, further comprising a next reception time calculation module configured to calculate and predict the next reception time using content of the message.

19. The apparatus of claim 17, further comprising a database for storing the next reception time and the last energy received from each road user.
